(19) United States
(12) Patent Application Publication
(10) Pub. No.: US 2024/0351368 A1
(43) Pub. Date: Oct. 24, 2024

(54) Disc Wheel for a Vehicle

(71) Applicant: Bayerische Motoren Werke Aktiengesellschaft, Muenchen (DE)

(72) Inventors: Andreas ADAM, Muenchen (DE); Florian FASCHINGER, Garching (DE)

(21) Appl. No.: 18/684,973

(22) PCT Filed: Sep. 5, 2022
(86) PCT No.: PCT/EP2022/074557

§ 371 Date: Feb. 20, 2024

(30) Foreign Application Priority Data
Sep. 21, 2021 (DE) 10 2021 124 332.7

(51) Int. Cl. B60B 3/08; B60B 21/02; B60C 23/04

(52) U.S. Cl. CPC B60B 3/087; B60B 21/026; B60C 23/0498

(57) ABSTRACT

An apparatus for a single-track motor vehicle includes a first wheel disc and a second wheel disc. The first wheel disc and the second wheel disc are configured on the wheel rim so as to be mutually spaced apart in a transverse direction parallel to the rotation axis (A) of the disc wheel, and extend from the wheel rim in the direction of the wheel hub. The wheel discs converge in the direction of the wheel hub and are connected to one another in such a manner that at least one cavity between the wheel discs and the wheel rim is formed. At least one cutout toward the at least one cavity is formed in a rim well of the wheel rim.

### BACKGROUND AND SUMMARY

The disclosure relates to a disc wheel for a vehicle, in particular a single-track motor vehicle, having a wheel hub for assembling the disc wheel on the vehicle, which wheel hub is disposed concentrically with a rotation axis of the disc wheel, a wheel rim which is likewise concentric with the rotation axis, and a first and a second wheel disc.

In principle, disc wheels have a substantially closed area between the wheel hub and the wheel rim, and no spokes or stays with cutouts therebetween. Air turbulences are reduced by the closed areas in disc wheels, so that the closed areas have a positive effect on the aerodynamics of the vehicle.

For this purpose, it is already known in the prior art to provide sheet metal panels or other materials which provide in each case a closed area toward one of the sides of the disc wheel and extend from the wheel rim to the wheel hub. In order to guarantee a sufficient stability of the disc wheel, comparatively thick sheet metal panels or materials are chosen, this resulting in a high and therefore disadvantageous weight of the disc wheels known in the prior art.

In order to reduce the weight of corresponding disc wheels, a multiplicity of disc wheels for vehicles and for single-track motor vehicles are already known from the prior art, in which the area between the wheel hub and the wheel rim is not closed and spokes or stays with cutouts therebetween are configured. However, likewise comparatively thick sheet metal panels or materials are required for this purpose in order to guarantee a sufficient stiffness or component strength.

It is therefore an object of the present disclosure to provide a disc wheel for a vehicle, in which a sufficient stiffness or component strength is guaranteed and the weight is further reduced.

This and other objects are achieved by the combination of features according to this disclosure. Proposed according to the disclosure is a disc wheel for a vehicle, in particular a motor vehicle, preferably a single-track motor vehicle, or a bicycle or an electric bicycle, having a wheel hub for assembling the disc wheel on the vehicle, which wheel hub is disposed concentrically with a rotation axis of the disc wheel, a wheel rim which is likewise concentric with the rotation axis, and a first and a second wheel disc. The first wheel disc and the second wheel disc herein are configured on the wheel rim so as to be mutually spaced apart in a transverse direction parallel to the rotation axis of the disc wheel, and extend in each case from the wheel rim in the direction of the wheel hub. Furthermore, the wheel discs converge in the direction of the wheel hub and are connected to one another in such a manner that at least one cavity between the wheel discs and the wheel rim is formed. Moreover, at least one cutout toward the at least one cavity is formed in a rim well of the wheel rim. The disc wheel herein is in particular configured as a front wheel or a rear wheel of the vehicle.

It is advantageous here that, firstly, the weight of the disc wheel is reduced by the cavity. By virtue of the at least one cutout, the cavity is fluidically connected to a tire fitted to the wheel rim, or to the interior of the tire, so that the internal pressure of the tire is prevalent in the cavity. As a result, the stiffness of the disc wheel in this region is increased, as a result of which the two wheel discs can in turn be of a narrower configuration in order to further reduce the weight. Moreover, the at least one cutout additionally reduces the weight of the disc wheel. However, in comparison to a wheel rim with a completely opened cavity, the stiffness of the disc wheel is advantageously increased by virtue of the rim well.

In one advantageous variant of embodiment it is provided that a multiplicity of cutouts are formed in the rim well of the wheel rim. The weight of the disc wheel is further minimized in this way.

The disc wheel is preferably configured in such a manner that the multiplicity of cutouts are disposed so as to be uniformly spaced apart from one another in a circumferential direction of the rim well. It is furthermore advantageous for the respective cutout to be configured so as to be centric in the transverse direction in the rim well. An imbalance created by the cutouts is avoided in this way.

In one preferred embodiment of the disclosure, the at least one cavity between the two wheel discs and/or the rim well are/is configured so as to be V-shaped or U-shaped in a cross section. It is favorable here that a cross section of this type provides a sufficient size of the cavity for increasing stiffness, and the material input of the corresponding components is simultaneously kept minimal, as a result of which the weight of the disc wheel is optimized. However, further cross-sectional shapes such as, for example, a circular, elliptical, square, rectangular or triangular cross section of the cavity are also possible.

In one exemplary embodiment of the disclosure it is provided that the wheel rim has two mutually separate rim segments which, in terms of a symmetry plane of the disc wheel that is orthogonal to the rotation axis, are laterally inversed, and wherein the rim segments, while forming the at least one cavity, are connected to one another by the wheel discs and the rim well. The two rim segments herein serve for receiving a respective terminating bead of the tire.

Furthermore favorable is an embodiment in which the respective rim segment has in each case one rim shoulder. The rim shoulders are connected to one another by the rim well. It is advantageous here that the rim shoulders form the seat for the tire bead. The respective rim shoulder supports the tire base and ensures that the tire is flawlessly mounted. Moreover, it is advantageous for the rim shoulder to be inclined toward the center of the disc wheel.

In a further advantageous variant it is provided according to the disclosure that the at least one cutout is configured as a slot, square, rectangular, elliptical or circular. An embodiment as a slot is particularly advantageous here, as a result of which the weight is additionally reduced and the tension in the rim well simultaneously minimized. It is particularly favorable here for a radius of the cutout to be chosen as large as possible. The tension in the region of the radii drops in the case of a larger radius, and the stress concentration decreases as the radius is enlarged. In this way, the stiffness increases as the radii are enlarged.

In one variant of embodiment, the disc wheel according to the disclosure is configured in such a way that the first and the second wheel disc extend from the wheel rim to the wheel hub along at least one quarter of the distance in a radial direction between the wheel rim and the wheel hub, and furthermore preferably extend along half of the distance to the wheel hub. In this way, the cavity is optimally sized with a view to increasing the stiffness by virtue of the tire pressure.

In an alternative embodiment of the present disc wheel, it is furthermore provided that at least two reinforcement ribs, which extend from the first wheel disc to the second wheel disc and connect those, and in particular the rim well, to one another, are formed in the cavity. The reinforcement ribs here are disposed so as to be uniformly distributed about the rotation axis of the disc wheel. As a result, the weight of the wheel discs can be further reduced, because the diameter of the latter can be minimized since the resultant lower stiffness of the disc wheel is compensated for, or increased, by the reinforcement ribs.

In one advantageous variant of embodiment it is provided that a cavity is in each case formed between two respective adjacent reinforcement ribs of the at least two reinforcement ribs, and in particular one rib cutout is in each case formed in the respective reinforcement rib. It is favorable here that respective adjacent cavities are fluidically connected to one another, as a result of which the internal pressure of the tire is better and faster distributed in the cavity, or the cavities, in the event of a sudden high external compressive load of the tire, damage to the tire being able to be avoided in this way.

In one preferred embodiment of the disclosure, at least one reinforcement rib forms a rib cavity which is open toward the wheel rim. Furthermore, a sensor, in particular a tire pressure sensor, is disposed in the rib cavity, and/or an opening which leads to the rib cavity of the reinforcement rib and in which a further sensor and/or a valve is received is provided in one of the two wheel discs. Therefore, a sensor and/or a valve by way of which the tire is inflatable can be integrated as a functional element in the disc wheel by way of the cavity, or by way of the opening leading to the cavity, in one of the wheel discs.

In one exemplary embodiment of the disclosure, the disc wheel comprises at least two spokes which extend in each case from the first wheel disc and the second wheel disc to the wheel hub and connect those to one another. Moreover, the spokes are disposed so as to be uniformly distributed about the rotation axis of the disc wheel. A void which is free of any material and by way of which the weight of the disc wheel is further reduced can be configured between the spokes.

In a further advantageous variant it is provided according to the disclosure that the disc wheel is integrally configured. The stiffness of the disc wheel is particularly advantageous in this way.

Materials which can be considered as materials for the disc wheel, or for the components which are configured to be mutually integral, include in particular aluminum alloy castings, steel, or else fiber-reinforced materials with a thermosetting or thermoplastic matrix. Accordingly, the disc wheel can be produced by a casting method, a sintering method, a steel welding method, or by methods for producing fiber-composite components. Rotary gravity die-casting, and/or die-casting using a plurality of, in particular two, sand cores, can in particular be used as a casting method.

The features disclosed above can be combined with one another in an arbitrary manner to the extent that this is technically possible and is not contradictory.

Other advantageous refinements of the disclosure are characterized in the dependent claims, or are illustrated in more detail hereunder in conjunction with the description of the preferred embodiment of the disclosure by means of the figures in which:

### BRIEF DESCRIPTION OF THE DRAWINGS

FIG. 1 shows a sectional view of a disc wheel for a vehicle;

FIG. 2 shows a view from above of the disc wheel for a vehicle; and

FIG. 3 shows a schematic view of the disc wheel for a vehicle.

### DETAILED DESCRIPTION OF THE DRAWINGS

The figures are schematic and by way of example. In the figures, the same reference signs denote identical functional and/or structural features.

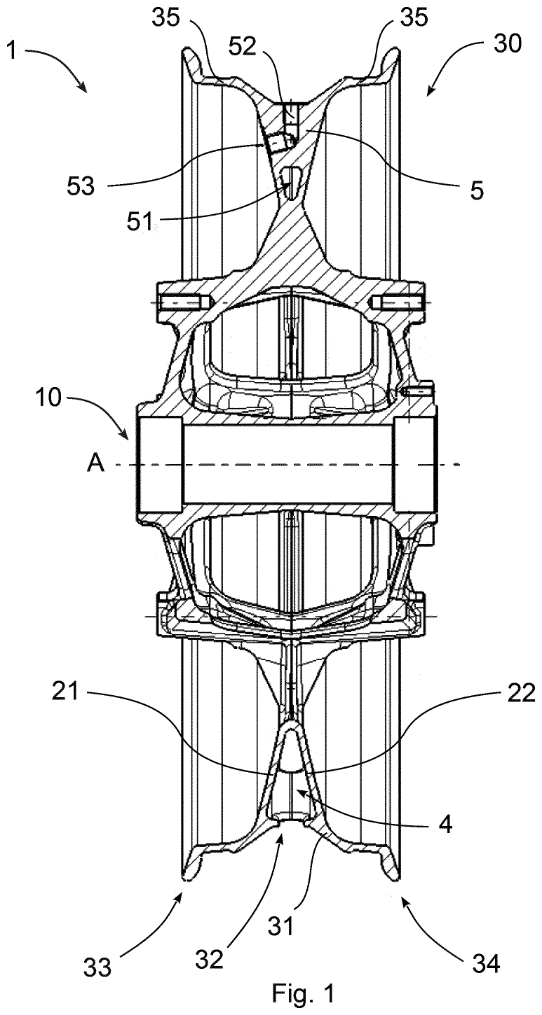

Illustrated in FIG. 1 is a sectional view of a disc wheel 1 for a single-track motor vehicle. The disc wheel 1 is integrally configured and comprises a wheel hub 10 for assembling the disc wheel 1 on the vehicle, which wheel hub 10 is disposed concentrically with a rotation axis A of the disc wheel 1, a wheel rim 30 which is likewise concentric with the rotation axis A, and a first and a second wheel disc 21, 22. The first wheel disc 21 and the second wheel disc 22 are configured on the wheel rim 30 so as to be mutually spaced apart in a transverse direction parallel to the rotation axis A of the disc wheel 1, and extend in each case from the wheel rim 30 in the direction of the wheel hub 10. Moreover, the wheel discs 21, 22 converge in the direction of the wheel hub 10 and are connected to one another in such a manner that a cavity 4 between the wheel discs 21, 22 and the wheel rim 30 is formed. Furthermore, the at least one cavity 4 between the two wheel discs 21, 22 and the rim well 31 are configured so as to be V-shaped in a cross section.

Furthermore, at least one cutout 32 toward the at least one cavity 4 is formed in a rim well 31 of the wheel rim 30, as a result of which the cavity 4 is able to be fluidically connected to a tire which is able to be fitted to the wheel rim, or to the interior of the tire, so that the internal pressure of the tire is prevalent in the cavity. The respective cutout 32 is configured so as to be centric in the transverse direction in the rim well 31.

Moreover, the wheel rim 30 has two mutually separate rim segments 33, 34 which, in terms of a symmetry plane of the disc wheel 1 that is orthogonal to the rotation axis A, are laterally inversed. Furthermore, the rim segments 33, 34, while forming the at least one cavity 4, are connected to one another by the wheel discs 21, 22 and the rim well 31. The respective rim segment 31, 32 has in each case one rim shoulder 35, and the rim shoulders 35 are connected to one another by the rim well 31.

Three reinforcement ribs 5 are formed in the cavity 4 of the disc wheel 1, wherein only one of the reinforcement ribs is illustrated in FIG. 1. The reinforcement ribs 5 extend from the first wheel disc 21 to the second wheel disc 22 and connect those, and the rim well 31, to one another. Moreover, the reinforcement ribs 5 are disposed so as to be uniformly distributed about the rotation axis A of the disc wheel 1. A cavity 4 is in each case formed between two adjacent reinforcement ribs 5, and the respective reinforcement rib 5 comprises in each case one rib cutout 51, as a result of which the adjacent cavities 4 are fluidically connected directly to one another.

The reinforcement rib 5 illustrated in FIG. 1 forms a rib cavity 52 which is open toward the wheel rim 30. A tire pressure sensor is disposed in the rib cavity 52, and an opening 53 which leads to the rib cavity 52 and in which a valve is received is provided in the first wheel disc 21.

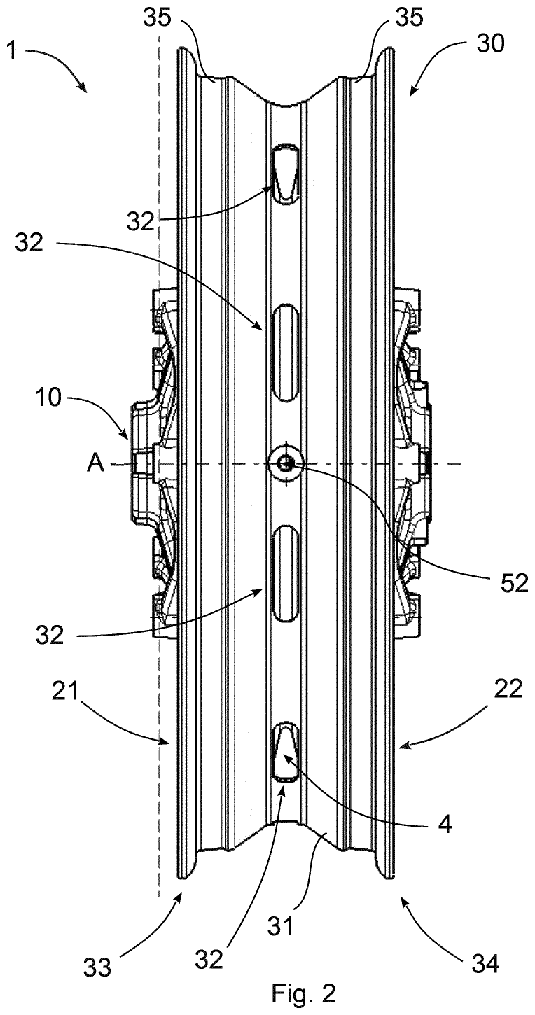

FIG. 2 shows a view from above of the disc wheel 1 for a single-track motor vehicle. Since this here is the disc wheel 1 illustrated in FIG. 1, only features will be discussed hereunder which are not shown in FIG. 1.

Accordingly, it can be seen in FIG. 2 that a multiplicity of cutouts 32 are formed in the rim well 31 of the wheel rim 30. The multiplicity of cutouts 32 are disposed so as to be uniformly spaced apart from one another in a circumferential direction of the rim well 31. Moreover, the respective cutout 32 is configured as a slot.

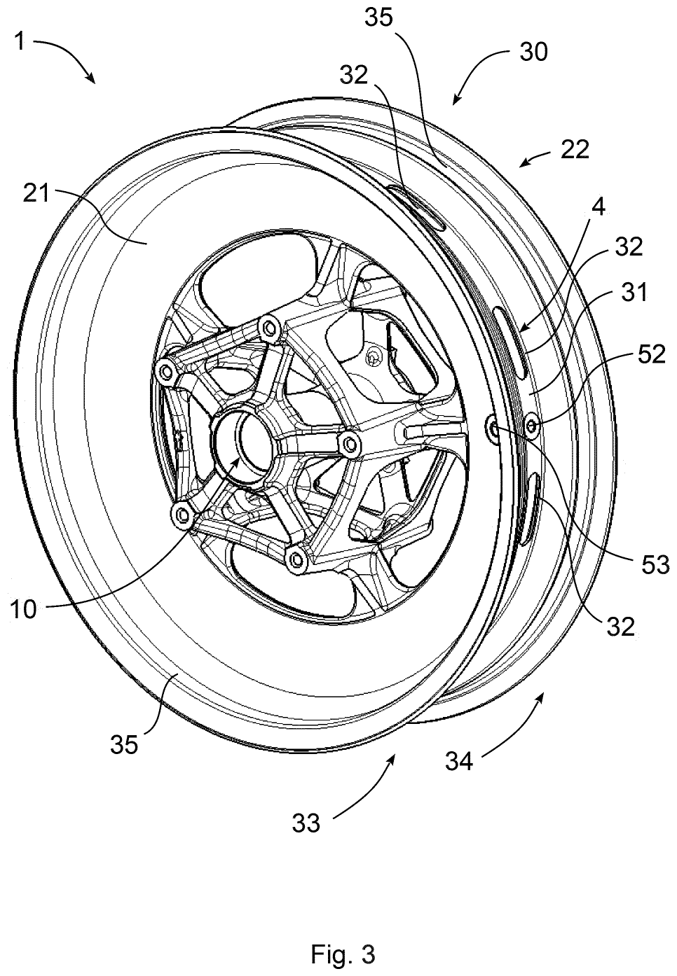

Illustrated in FIG. 3 is a perspective view of the disc wheel 1 illustrated in FIGS. 1 and 2. Accordingly, likewise only features are discussed which are not shown in the previous FIGS. 1 and 2.

The first and the second wheel disc 21, 22 herein extend from the wheel rim 30 to the wheel hub 10 approximately along a quarter of the distance in a radial direction between the wheel rim 30 and the wheel hub 10. Moreover, the disc wheel 1 comprises five spokes 60 which extend in each case from the first wheel disc 21 and the second wheel disc 22 to the wheel hub 10 and connect those to one another. Furthermore, the spokes 60 are disposed so as to be uniformly distributed about the rotation axis A of the disc wheel 1.

The disclosure in terms of its embodiment is not limited to the preferred exemplary embodiments stated above. Rather, a number of variants which utilize the illustrated solution even in embodiments of a fundamentally different type are conceivable.

1.-14. (canceled)

15. An apparatus for a single-track motor vehicle, comprising:
a disc wheel, wherein single-track motor vehicle includes a wheel hub configured to assemble the disc wheel on the vehicle, the wheel hub being disposed concentrically with a rotation axis (A) of the disc wheel, a wheel rim which is likewise concentric with the rotation axis (A), and a first and a second wheel disc, wherein
the first wheel disc and the second wheel disc are configured on the wheel rim so as to be mutually spaced apart in a transverse direction parallel to the rotation axis (A) of the disc wheel, and extend from the wheel rim in the direction of the wheel hub,
the wheel discs converge in the direction of the wheel hub and are connected to one another in such a manner that at least one cavity between the wheel discs and the wheel rim is formed, and
at least one cutout toward the at least one cavity is formed in a rim well of the wheel rim.

16. The apparatus according to claim 15, wherein a multiplicity of cutouts are formed in the rim well of the wheel rim.

17. The apparatus according to claim 16, wherein the multiplicity of cutouts are disposed so as to be uniformly spaced apart from one another in a circumferential direction of the rim well.

18. The apparatus according to claim 17, wherein the respective cutout is configured so as to be centric in the transverse direction in the rim well.

19. The apparatus according to claim 18, wherein the at least one cavity between the two-wheel discs and/or the rim well are/is configured so as to be V-shaped or U-shaped in a cross section.

20. The apparatus according to claim 19, wherein the wheel rim has two mutually separate rim segments which, in terms of a symmetry plane of the disc wheel that is orthogonal to the rotation axis (A), are laterally inversed, and wherein the rim segments, while forming the at least one cavity, are connected to one another by the wheel discs and the rim well.

21. The apparatus according to claim 20, wherein the respective rim segment has one rim shoulder, wherein the rim shoulders are connected to one another by the rim well.

22. The apparatus according to claim 21, wherein the at least one cutout is configured as a slot, square, rectangular or circular.

23. The apparatus according to claim 22, wherein the first and the second wheel disc extend from the wheel rim to the wheel hub along at least a quarter of the distance in a radial direction between the wheel rim and the wheel hub.

24. The apparatus according to claim 23, wherein at least two reinforcement ribs, which extend from the first wheel disc to the second wheel disc and connect those, and in particular the rim well, to one another, are formed in the cavity, and wherein the reinforcement ribs are disposed so as to be uniformly distributed about the rotation axis (A) of the disc wheel.

25. The apparatus according to claim 24, wherein a cavity is formed between two respective adjacent reinforcement ribs of the at least two reinforcement ribs, wherein a rib cutout is formed in the respective reinforcement rib.

26. The apparatus according to claim 25, wherein at least one reinforcement rib forms a rib cavity which is open toward the wheel rim, wherein a tire pressure sensor, is disposed in the rib cavity, and/or an opening which leads to the rib cavity of the reinforcement rib and in which a further sensor and/or a valve is received is provided in one of the two wheel discs.

27. The apparatus according to claim 26, further comprising: at least two spokes which extend from the first wheel disc and the second wheel disc to the wheel hub and connect those to one another, wherein the spokes are disposed so as to be uniformly distributed about the rotation axis (A) of the disc wheel.

28. The apparatus according to 27, wherein the disc wheel is integrally configured.
